(19) United States
(12) Patent Application Publication
(10) Pub. No.: US 2021/0089691 A1
(43) Pub. Date: Mar. 25, 2021

(54) METHOD, SYSTEM AND COMPUTER-READABLE STORAGE MEDIUM FOR SIMULATING CLOTHING COMFORT AND METHOD FOR MANUFACTURING CLOTHING

(71) Applicant: Fengping ZHAO, Shanghai (CN)

(72) Inventor: Fengping ZHAO, Shanghai (CN)

(21) Appl. No.: 17/017,354

(22) Filed: Sep. 10, 2020

(30) Foreign Application Priority Data
Sep. 23, 2019 (CN) 201910901617.3

(51) Int. Cl. G06F 30/20; G06F 30/10; G06T 19/20

(52) U.S. Cl. CPC G06F 30/20; G06F 2113/12; G06T 19/20; G06F 30/10

(57) ABSTRACT

A method, a system and a computer-readable storage medium for simulating clothing comfort and a method for manufacturing clothing. The method for simulating the clothing comfort includes the following steps. A main structure of clothing is established. A clothing entity design is performed on the main structure of the clothing. After the clothing entity design is completed, and sketches are outputted. First of all, the present invention can scientifically simulate the virtual fitting on wearing comfort, and adjust the production of the clothing in simulation to meet the difference of individual comfort requirements. Further, it is intelligent clothing manufacturing. According to a clothing version adjusted in the simulation and combined with the production of human body data to meet the differences in individual clothing manufacturing, it can manufacture fitting and comfortable clothes.

### CROSS-REFERENCE TO RELATED APPLICATIONS

This application claims the benefit of priority from Chinese Patent Application No. 201910901617.3, filed on Sep. 23, 2019. The content of the aforementioned applications, including any intervening amendments thereto, is incorporated herein by reference in its entirety.

### TECHNICAL FIELD

The present application relates to intelligent pattern design, pattern module fitting, somatosensory simulation and individual comfort calculation, and more particularly to a method, a system and a computer-readable storage medium for simulating clothing comfort and a method for manufacturing clothing.

### BACKGROUND

More automated simulation systems and processes are required to satisfy the increasing demands for clothing personalization, production, design, and supply chains, and such automated simulation systems and processes are tradable together with clothing. Since there are objective and subjective differences in comfort and aesthetic between individuals who wear the same clothes, it is significant to accurately provide individuals with clothes that is comfortable and suits them well, which is a difficult point of the core technical system for new industries and is needed in design and structure stages of clothing.

Document 1: Chinese Patent Application Publication No. 104821006 A discloses a dynamic clothing simulation method based on human body hybrid bounding boxes. Firstly, the MCASG graph theory algorithm and the K-means clustering algorithm are used to perform a primary segmentation and a secondary segmentation for a human body model, respectively to obtain the head, upper arms, low arms, upper legs, low legs and torso of the human body model. Secondly, the bonding boxes suitable for the shape of different parts of the human body are selected. For example, a spherical bounding box is used for the hips and female breasts, a cylindrical bounding box is used for the arms and legs, and an elliptical cylindrical bounding box is used for the torso. Finally, a spring-mass model based on a triangular mesh of the clothing model is constructed for modelling the clothing, followed by the collision detection and response, and then the realistic real-time clothing simulation is realized. The simulation result shows the feasibility and superiority of the described method. The dynamic garment simulation method based on human body hybrid bounding boxes can effectively improve the collision detection speed of the clothing and the human body model, and shorten the collision processing time.

Document 2: Chinese Patent Application Publication No. 104036061 A discloses a method and a system for clothing simulation. The method includes the following steps. Parameters are inputted to the simulation system through the parameter definition module to obtain a solution, where the input parameters include physical properties of clothing materials, human thermal physiological parameters, environmental climate parameters and human activity behavior parameters. A simulation system involving human body, clothing and environment is established, where the simulation system includes an environmental climate boundary model, a multi-node human thermal physiological balance adjustment mathematical model, and a clothing and environmental heat and moisture transfer and exchange mathematical model. The clothing environment digital simulation equation and the human thermal physiological balance adjustment digital simulation equation are established for the clothing and environmental heat and moisture transfer and exchange mathematical model and the multi-node human thermal physiological balance adjustment mathematical model, respectively. A multi-node modular calculation model is established in the simulation system. Finally, simulation data is obtained, and 3D graphics that show the performance of the clothing is outputted through the image output module.

Document 3: Chinese Patent Application Publication No. 109299989 A discloses a virtual reality fitting system which relates to virtual reality technology and includes a display module, a clothing control module, a clothing selection module, a clothing simulation module, an interactive module, a trading system module, an information statistics module, and a photo sharing module. These modules cooperate with each other to form a fully functional virtual reality fitting system with complete functions. The virtual reality fitting system of the invention, combined with the existing somatosensory virtual fitting system, makes up for the lack of 3D clothing display capabilities and incomplete supporting functions. Furthermore, the virtual reality fitting system also integrates Kinect somatosensory technology, augmented reality technology, and OpenGL three-dimensional rendering technology to become a somatosensory virtual fitting system with good user experience and relatively complete functions.

Document 4, Chinese Patent Application Publication No. 104637084 A discloses a method for establishing a virtual three-dimensional model of clothing which includes: obtaining two photos of the clothing; identifying the outlines and key nodes of the clothing photos; calculating and fitting the same fitting points of the two photos and then generating a basic version of the virtual three-dimensional model of clothing. Meanwhile, the invention also discloses a virtual fitting system using the above-mentioned method, and the fitting system allows users to easily and quickly establish a virtual three-dimensional model of the selected clothes when buying clothes online, realizing easy and efficient fitting.

Document 5, Chinese Patent Application Publication No. 104881557 A discloses a method for realizing dynamic simulation of human body clothing in computer that simulation effects of different materials are achieved through setting key steps in physical simulations. The method includes steps of human body modeling, human body model and clothing model preprocessing, calculating clothing simulations with mechanics knowledge, post-integration correction, collision detection and response. The invention proposes a large bending spring based on the traditional mass point spring model to produce a wrinkle effect, and it sets corresponding spring parameters according to the properties of different materials. Further, the invention adopts a comprehensive correction strategy for the mass point clothing, and proposes a sound collision response plan to fully consider the characteristics of each material. The traditional differentiations of clothing materials are mostly realized by a large number of parameter measurement and geometric methods, whereas the invention solves the disadvantages of the such as low efficiency and insufficient flexibility, realizing dynamic simulation of different materials in real time.

Document 6, Chinese Patent Application Publication No. 109978837 A discloses an evaluation method of fitness based on visual factors of clothing image which includes the steps of visual perception fitness evaluation and image recognition fitness evaluation. The visual perception fitness evaluation includes: extracting four visual factors from clothing images; and plugging the visual factors into the visual factor regression equation to obtain the visual perception fitness evaluation value Y. The image recognition fitness evaluation includes: subjecting gray threshold segmentation to clothing images; performing edge detection on the processed clothing images; and obtaining wrinkle factors. The fitness evaluation method of the invention evaluates both visual comfort and fitness, and the evaluation method is based on clothing images to extract the influence factors with relatively high correlation and then comes to an evaluation conclusion, realizing the unity of visual comfort and objective fitness evaluation.

Document 7: Chinese Patent Application Publication No. 106530064 A discloses a system and a method for evaluating wearing comfort of shoulder fitting simulation. The system includes modules of a user interface, a video processing, a model simulation and a comfort evaluation. The method includes the following steps: shooting and uploading a video of shoulder standardized fitting actions of an user through the user interface module to input the information which includes shoulder width, color and fabric of the top to be tried on; extracting shoulder parameters of the user and key frame information through the video processing module; completing a dynamic simulation of the shoulder fitting through the model simulation module; outputting a result of the comfort test through the evaluation module. The invention displays a shoulder fitting effect of user with authenticity, reliability and convenience, and can observe a dynamic dressing effect of the back. Furthermore, an evaluation result of the shoulder comfort after wearing a specific type of top can be obtained directly, and the invention has low application cost, which is beneficial to attracting customers and improving virtual try-on experience of users to reduce the return rate.

Document 8: Chinese Patent Application Publication No. 105628900 A discloses a system and a method for evaluating wearing comfort. The system includes a human body model, a contact force sensor, an optical image acquisition unit and a data processing apparatus. The human body model is a hollow shell made of transparent material, the surface of the hollow shell has several insert holes corresponding to the key parts of the human body model. At least one of the contact force sensor is inserted in the insert hole; the hollow shell is equipped with the optical image acquisition unit; the data processing apparatus includes a data comprehensive analysis module, a contact force data processing module and a hairiness morphology data processing module. The invention adopts a high-precision contact force sensor to acquire data, and an optical image acquisition unit to acquire the image of the contact state between the surface hairiness of the clothing and the human body model. The operation of the invention is convenient and simple, and the experimental data is objective and accurate, resulting in high reliability. The force sensor is used to directly obtain the contact force instead of the friction force between the measured fiber and the skin, which is closer to the actual influence of the hairiness on the human body when the clothes are worn.

Document 9: Chinese Patent Application Publication No. 106502399 A discloses a method, a device and a system for virtual fitting and a method and a device for establishing three-dimensional fabric material library. The virtual method includes the following steps: extracting outline parameters of a human body based on a human body image to generate a human body model; obtaining specifications of a target clothing; putting the target clothing on the human body model for display; outputting surface pressure of the target clothing at each part of the human body model according to fabric material of the target clothing and the outline parameters of human body. In the invention, the target clothing is put on the human body model that is generated according to the actual parameters of the human body for display, and outputs the surface pressure of each part of the human body model, so that the users can intuitively obtain the comfort level when wearing the target clothing. Furthermore, the users obtain the image and the pressure parameters after wearing, so that the users can perceive the immersive wearing effect of the clothing, which overcomes the defect of only visual effects in the prior art.

Currently, this problem is solved in a separate manner, that is, there is no direct and accurate correspondence between the finished product and the design scheme. For example, a theory and a basic of the design process or the structural system are established at first, and then the theory and the basic are tested through the garment entity. As a result, the clothing for consumers is hard to meet individual aesthetic and somatosensory requirements, causing stagnant inventory.

Furthermore, the conventional method cannot quantify the key selection index of comfort. There is a failure to design and clothing making according to individual comfort requirements. The object of the present invention is to solve those problems and new problems caused by the above.

### SUMMARY

In view of the defects in the prior art, the object of the present invention is to provide a method, a system and a medium for simulating the clothing comfort to solve the above technical problems.

The present disclosure provides a method for simulating the clothing comfort, comprising:
1) establishing a main structure of clothing;
2) performing a clothing entity design on the main structure; and
3) outputting sketches to finish the clothing entity design.

In an embodiment, the step 1 comprises:
1.1) establishing a dynamic basic version;
1.2) obtaining a rigid support structure and an initial style support structure through regression calculation on the basis of the dynamic basic version;
1.3) obtaining a pressure comfort value of a contact surface;
if the pressure comfort value is not within a preset comfort value range, marking out-of-range influencing elements and returning to the step 1.2;

if the pressure comfort value is within the preset comfort value range, proceeding to a next step;
1.4) obtaining an elastic structure of material through regression calculation on the basis of the dynamic basic version; and
1.5) obtaining a weight pressure of the clothing and accessories on the clothing and an increased pressure of shrinkage;
if the weight pressure of the clothing and accessories on the clothing and the increased pressure of shrinkage are not within the preset comfort value range, marking the out-of-range influencing elements and returning to step 1.4;
if the weight pressure of the clothing and accessories on the clothing and the increased pressure of shrinkage are within the preset comfort value range, proceeding to a next step.

In an embodiment, the step 1.1 comprises:
1.1.1) acquiring a size data set;
1.1.2) obtaining baseline architect;
1.1.3) establishing a dynamic basic version in combination with a size data set and a baseline architect.

In an embodiment, the step 2.1 comprises:
2.1) obtaining an outline of the main structure of the clothing, wherein the outline comprises plane outline design drawings of front, left, right and back;
2.2) converting the outline into the design plans, wherein the plane outline design drawings are converted into design plans through dots and lines; and
2.3) marking the processing elements on the design plans, wherein the processing elements comprise overlapping areas, stitches and curved cut edges.

The present disclosure further provides a method for manufacturing clothing, comprising:
obtaining sketches through the method for simulating clothing comfort; and
manufacturing clothing according to the sketches.

The present disclosure further provides a system for simulating clothing comfort without style constraints, comprising:
a module M1 for constructing a main structure of clothing;
a module M2 for performing a clothing entity design on the main structure;
a module M3 for outputting sketches to complete the clothing entity design.

In an embodiment, the module M1 comprises:
a sub-module M1.1 for establishing a dynamic basic version;
a sub-module M1.2 for obtaining a rigid support structure and an initial style support structure through regression calculation on the basis of the dynamic basic version;
a sub-module M1.3 for obtaining a pressure comfort value of a contact surface;
wherein if the pressure comfort value is not within a preset comfort value range, the out-of-range influencing elements are marked and the sub-module M1.2 is triggered;
if the pressure comfort value is within the preset comfort value range, a sub-module M1.4 is triggered;
a sub-module M1.4 configured to obtain an elastic structure of material through regression calculation on the basis of the dynamic basic version;
a sub-module M1.5 configured to obtain a weight pressure of the coating and accessories on the coating and an increased pressure of shrinkage;
if the weight pressure of the coating and accessories on the coating and the increased pressure of shrinkage are not within the preset comfort value range, the out-of-range influencing elements are marked, the sub-module M1.4 is triggered;
if the weight pressure of the coating and accessories on the coating and the increased pressure of shrinkage are within the preset comfort value range, the module M2 is triggered.

In an embodiment, the sub-module M1.1 comprises:
a sub-module M1.1.1 for acquiring a size data set;
a sub-module M1.1.2 for obtaining a baseline architect;
a sub-module M1.1.3 for establishing a dynamic basic version in combination with a size data set and a baseline architect.

In an embodiment, the module M2 comprises:
a sub-module M2.1 for obtaining an outline of the main structure of the clothing, wherein the outline comprises plane outline design drawings of front, left, right and back;
a sub-module M2.2 for converting the outline into the design plans, wherein the plane outline design drawings are converted into design plans through dots and lines.
a sub-module M2.3 for marking the processing elements on the design plans, wherein the processing elements comprise overlapping areas, stitches and curved cut edges.

The present disclosure further provides a non-transitory computer-readable storage medium having thereon stored computer programs, wherein the computer programs, when executed by a computer, causes the computer to perform the method for simulating the clothing comfort.

The advantages of the present invention are mainly reflected in the following aspects:

Compared with Document 1, the present invention is different on purposes, methods, inputs and outputs. Specifically, the present invention can be accurate to a specific position, a certain section of a specific part, a surface or even a point. The enclosing elements of the dynamic calculation come from the plane calculated based on the human body surface, and the simulation is to re-sew these calculated and cut planes. If a collision occurs, the present invention requires recursion to modify it and increase or decrease the plane size. The precise calculation of constraints is for the improvement of comfort.

Compared with Document 2, the present invention is different on objects, calculation methods, techniques, and sequences of process. Specifically, Document 2, using a specific human body data, displays the simulation effect through combing the analysis of materials and performance and the environmental factors. Whereas the present invention decomposes clothing production into several technological processes, and recursively calculate the best suitable clothing version through combining human body differences and comfort differences. Further, the present invention sews the pattern by using the inspection method, and attaches the pattern to a specific human body, then evaluates and modifies the pattern based on the physical properties of the fabric.

Compared with Document 3, the present invention is different on objects, calculation methods, techniques, and sequences of process. Specifically, Document 3, using a specific human body data by infrared collection, displays the style effect of the clothing through directly adding a layer of the clothing texture according to the human body data. Whereas the present invention makes a clothing pattern and a cutting surface that can be used to make clothing, and the area attached to the human body corresponds to the size of the cloth. Further, the purpose of the 3D visualization of the present invention is to inspect the sewing pattern and attach the pattern to a specific human body, then evaluate and modify the pattern based on the physical properties of the fabric.

Compared with Document 4, the present invention is based on the start point of the person and the corresponding clothing and the data during the clothing decomposition process, it can also modify the structure, material and version of the clothing according to the individual differences of the human body and comfort. Furthermore, the final fitting is also based on the individual clothing and fitting.

Compared with Document 5, the present invention is different on purposes, methods, inputs and outputs. Specifically, the present invention can be accurate to a specific position, a certain section of a specific part, a surface or even a point. The enclosing elements of the dynamic calculation come from the plane calculated based on the human body surface, and the simulation is to re-sew these calculated and cut planes. If a collision occurs, the present invention requires recursion to modify it and increase or decrease the plane size. The precise calculation of constraints is for the improvement of comfort.

Compared with Document 6, the present invention is different on the technical basis for the evaluation of fit and comfort. Specifically, the present invention is based on the decomposition of force, the calculation of the density and weight of physical materials, and the sharing of contraction force and tensile force at a specific position. Visually, in addition to fit, the present invention is more of somatosensory pressure heat maps.

Compared with Document 7, the present invention is different on objects, methods, and the technical basis for the evaluation of fit and comfort. Specifically, the present invention is based on the decomposition of force, the calculation of the density and weight of physical materials, and the sharing of contraction force and tensile force at a specific position. Visually, in addition to fit, the present invention is more of somatosensory pressure heat maps.

Compared with Document 8, the present invention is different on objects, methods, and the technical basis for the evaluation of fit and comfort. Specifically, the present invention is based on the decomposition of force, the calculation of the density and weight of physical materials, and the sharing of contraction force and tensile force at a specific position. In addition, the present invention is based on the start point of the person and the corresponding clothing and the data during the clothing decomposition process, it can also modify the structure, material and version of the clothing according to the individual differences of the human body and comfort. Furthermore, the final fitting is also based on the individual clothing and fitting instead of using a hollow shell as the model of human body to obtain the basic 3D data.

Compared with Document 9, the present invention is different on objects, methods.

1) Problem Difference

Document 9 is to visualize comfort in virtual fitting, allowing users to see outlines of different target garments corresponding to quantification of comfort. In the present invention, multiple indicators (not only the outlines and pressure) that affect the comfort of the dress are calculated. In the early, middle, and late stages of designing and making clothing, detailed small-area three-dimensional surfaces are created by combining the static state and action state of the target human body, and based on which, several key indicators that affect comfort are calculated. An auxiliary computer evaluates the changes in design details in real time to meet the expectations of producers and consumers under the conditions of meeting the comfort and style uniformity of customized clothing. Under the conditions of meeting the comfort of customized clothing and uniform style, it can meet the target objects of producers and consumers expected. In the early design, the physical property of the fabric is also an influencing factor of the inference calculation. Different fabrics are chosen to match the design of the clothing to make the produced clothing consistent with the visual perception when worn.

2) Object Difference

Document 9 is aimed at the visualized relationship between the ready-to-wear and the consumer, and the present invention is aimed at the design and processing relationship among the clothing designer, the fabric, the garment and the consumer's expectations. The present invention is an active intervention and reverse forecasting calculation method for the relationship between production and consumption.

3) Method Difference

Document 9 is based on computer vision in the image contour as a point cut. There are three obvious differences in the method of the present invention. Firstly, a reverse calculation and multiple iteration regression inference calculations, not a contour calculation, implement the method according to the expected design and the physical properties and weight of the accessory fabric in a classical physical way (including the normal line and tangent surface decomposition of the force surface). Secondly, a human body model is accurate to normal of small-area three-dimensional surface in the static state and the action state, respectively. The physical and mechanical effects introduced by different materials are also calculation base of the of the present invention. Therefore, the present invention is a hybrid simulation calculation method of solid geometry and classical physics, rather than a computer vision calculation. Thirdly, the calculation method of the present invention is involved from the early stage of the design. The calculation and implementation are dynamic, real-time, predictable, capable of realizing forward and reverse reasoning for the entire process, and then feedback to the current implementation stage, which can be regarded as a feedback calculation collection that contains multiple small loops in a large loop. What the final consumer or designer sees will also change according to variables of the design and the fabric, which is a dynamic process.

4) Objective Difference

Document 9 is to obtain images and pressure parameters after wearing. This kind of professional single objective only has a partial effect on wearing simulation, and the body feeling often undergoes essential changes after being matched with other indicators. In the present invention, the comfort is a comprehensive index based on stress, elasticity, gravity, friction, pressure, tension. Specifically, the comfort even if the user is more somatosensory to meet the somatosensory evaluation of the possibility of dating during normal stretching after wearing, but also for the designer to obtain the target in real time The static and dynamic wearing experience of body type users is quantified, assisting in modifying the version and design, and ensuring the consistency of customization in the process of manufacturing. The comfort is a kind of somatosensory evaluation that can be introduced when the user performs normal stretching actions after the clothes meet the wearing requirements. The comfort provides designers with real-time access to the quantification of the static and dynamic wearing feeling of the target body user, which assists in modifying the pattern and design, and ensure the consistency of customization in the manufacturing process.

The present invention can scientifically simulate the virtual fitting on wearing comfort, and adjust the production of the clothing in simulation to meet the difference of individual comfort requirements. Further, it is intelligent clothing manufacturing. According to a clothing version adjusted in the simulation and combined with the production of human body data to meet the differences in individual clothing manufacturing, it can manufacture fitting and comfortable clothes. Finally, it can also provide a quick feedback design, which can quickly evaluate and improve design styles, and quickly reflect the modification and enrich the design with the goal of the final wearing experience and visual matching of the dress. It is used to improve the intelligent pattern and can quickly deduct and generate scientific styles, so that designers are provided with the basis of pattern simulation physical automation tools.

### BRIEF DESCRIPTION OF THE DRAWINGS

Other advantages and features of the invention will become apparent when viewed in light of the detailed description of the non-limiting embodiment when taken in conjunction with the attached drawings.

FIG. 1 is a flow chart of a method for simulating individual comfort without style constraints according to an embodiment of the present disclosure.

### DETAILED DESCRIPTION OF EMBODIMENTS

The present disclosure will be described in detail below in conjunction with specific embodiments. The embodiments are described to help those skilled in the art to further understand the present disclosure, but are not intended to limit the scope of the present disclosure. It should be noted that for those of ordinary skill in the art, changes and modifications can be made without departing from the concept of the present disclosure.

In view of the above-mentioned defects in the prior art, the technical problems to be solved by the present disclosure are embodied in the following links:

Link 1, the version of clothing is divided into a structural part and a design part. The structure part is further divided into three parts: rigid support structure, style support structure and material elastic structure. The design part is further divided into three parts: physical design part, flexible selection part and accessory part.

Link 2, the rigid support structure and the style support structure in the structure part determine the overall force and the decomposition of the force. It is necessary to obtain a range of comfort of each force surface according to the total area and weight of a fabric, tension and its distribution of the contact surface.

Link 3, the material elastic structure is an element that intervenes to ensure the integrity of the design body when the comfort of the bearing surface is reduced below the individual tolerance but the physical design parts cannot be changed

Link 4, the physical design parts are realized by professional design and follow the objective laws and aesthetic needs. Once finished, the physical design parts begin to calculate the structure mentioned in the previous Link 2.

Link 5, the flexible selection part is a design part that can be parallel to the material elastic structure to meet the comfort index, which is one of the two adjustable parts to keep the style as unchanged as possible. The design to meet the comfort needs is started with the mechanical structure and pressure decomposition to ensure the comfort pressure range of the key parts.

Link 6, if the total weight and mechanical balance of the accessory part is increased, it would go back to the aforementioned three links of link 1, link 2, and link 4 to fit, disassemble and recalculate in order to achieve the modify.

Link 7, the complete model of the simulation is combined together at last. Then the 3D rendering output preview confirms the range of pressure at each angle that meets the comfort after mechanical decomposition, and the preference and tolerance of individual for style and local pressure comfort, achieving the overall comfort without style constraints.

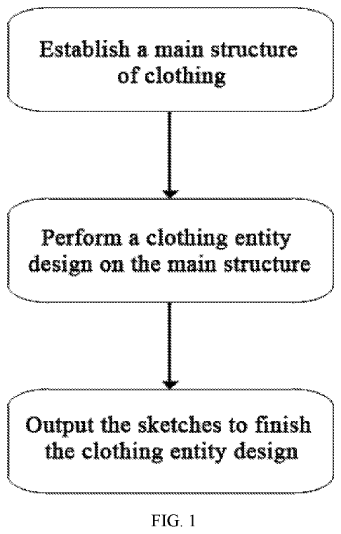

As shown in FIG. 1, the present disclosure provides an individual comfort simulation method without style constraints. The entire simulation process is divided into two stages of linear relationship, where each stage needs loop feedback itself and cross-stage loop feedback, and then outputs 3D visualization simulation as shown in FIG. 1.

The first stage is building a main structure: selecting one of the several basic versions that are most similar to the design target as a baseline architect in combined with a key size data set of the main structure (a multi-dimensional array [X, Y, Z, N, M, O, P], where XYZ represents coordinates; N represents normal; M represents horizontal section tension; O represents density; P represents somatosensory fit coefficient. The set usually includes at least 300 arrays, and up to 1000 groups). The key data set includes the size of hundreds of positions selected from the human body and the comfort constraint status corresponding to the size in the version to dynamically construct a three-dimensional dynamic version that meets the key size data set. The purpose of the dynamic base version is to carry out the first round of mechanical decomposition and prediction calculations (As long as there are definite changes, they need to be rounded again): calculating the total area and total weight according to the default physical properties of the fabric; calculating the gravity direction, normal direction, surface tension and shrinkage pressure of all pivots through Newtonian mechanics decomposition. The various forces corresponding to the comfort are within the comfort range by default. If there is a force close to or exceeding the median of the range when the budget is first deduced, the option would remind: A, replace the fabric or attachment material; B, adjust the style version of the main structure.

The increased weight caused by the addition of the auxiliary structure on the dynamic basic version and the change of comfort caused by the increasing pressure index owing to reducing the force surface would form a rigid support structure and a style support structure through regression calculation. The corresponding joints of different style modules obtained through an active selection will be pre-positioned in the physical position of the three-dimensional coordinate space, which supports position movement of 1-2 cm and the change of material, texture and color in the module. The comfort of all contact surfaces will be fully calculated again after the achievement of the active selection. If the comfort value exceeds the comfort range of 80%˜120%, it will be modified again according to the rigid support algorithm, and the regression calculation will be performed until the comfort value falls into the comfort range of 80% ˜120%. At last, a pressure calculation of all contact surfaces will be adjusted according to an elastic tension of the material in the calculation of the material elastic structure. Pattern grading is according to the size without elastic deformation by default. An effect of loose and wide elasticity on comfort is limited to a pressure of a normal contact surface. A contraction force in the horizontal direction follows fabric comfort category index. Usually, a stretching deformation of elastic fabric does not exceed 30%, the best is less than 10%. In a tight type, a size is that can provide users with adjustments. A contraction may increase the pressure value, and a total pressure is a final overall weight pressure and the increased pressure of contraction. The regression calculation will be performed until the comfort value falls into the comfort range of 90%-110%.

The second stage is to realize design elements. After the physical design on the basis of the 3D modeling constructed in the first stage, the computer triangulates the surfaces of the designed 3D modeling. The side length can be selected precisely in a range of 5-25 mm. At vertexes of each triangle, the elastic scale of the fabric material can be increased within the length range of the sides (the length contraction elasticity of the standard fabric is 5%). The position of the vertex can be moved in the three directions of XYZ. If the vertex is deleted, its connected sides will also be deleted. In the flexible selection part and the accessory part, the addition of parts is based on the need of the design. The area of the flexible selection part should include the calculation start point, the calculation end point and the fitting point on the boundary. The flexible selection part itself can serve as an independent optional material, fabric and color. The accessory part is fixed in size and shape, and it can be moved to a specific position. The material and shape can only be selected and cannot be modified, but the introduction of weight that changes the force requires regression calculation.

A production drawing is output as a dxf or plt format file and printed. The production drawing determines the pattern, style, fabric, accessories, and can be visually output on the 3D modeling. A dressing effect of the PLT production drawing is previewed, and the force distribution 3D modeling is constructed according to the mechanical data (similar to that the heat map distribution distinguishes the size and distribution of forces in different parts by color) so as to predict a production of the design, and meet the individual preference of comfortable design style.

The present disclosure provides a method for making clothing, including:
Step 1. An establishment of a main structure
Step 2: A physical design on the main structure
Step 3. A Completion of the physical design and an output of a pattern
Step 4. A clothing manufacture according to the pattern

Those skilled in the art should know that, in addition to a computer-readable program coding, logical programming of the method steps is also possible to make the system, the device and the various modules provided by the present invention implement the same program in the form of logic gates, switches, specific integrated circuits, programmable logic controllers, and embedded microcontrollers. Therefore, the system, the device and the various modules provided by the present invention can be regarded as a kind of hardware component, and the modules for implementing various programs can also be regarded as the structure within the hardware component. The modules for realizing various functions can be regarded as both software programs for realizing methods and structures within hardware components.

The specific embodiments of the present invention have been described above. It should be understood that the present invention is not limited to the above specific embodiments, and those skilled in the art can make various changes or modifications within the scope of the claims, which shall fall within the scope of the present disclosure. In addition, various embodiments can be combined with each other, in a manner that enables the implementation of the present invention by those skilled in the art, and the combination of the embodiments that is expected in an inappropriate way will not be considered as falling within the spirit of the present invention.

What is claimed is:

1. A method for simulating clothing comfort, comprising:
1) establishing a main structure of clothing which is a contact surface between the clothing and a human body;
2) performing a clothing entity design on the main structure of clothing and marking processing elements on sketches;
3) finishing the clothing entity design and outputting the sketches;
wherein the step 1 comprises:
1.1) establishing a dynamic basic version in combination with a size data set and a baseline architect; wherein a basic version that is most similar to a design target is selected as the baseline architect, and the dynamic basic version is dynamically constructed according to the baseline architect and the size data set;
1.2) obtaining a rigid support structure and an initial style support structure through regression calculation on the basis of the dynamic basic version; wherein the rigid support structure is a support structure of the dynamic basic version that supports a contact surface of the the human body and the dynamic basic version;
1.3) obtaining a pressure comfort value of the contact surface according to a total area and weight of a fabric, a tension and a distribution of the contact surface, and an overall force and force decomposition that are determined by the rigid support structure and the initial style support structure;
wherein if the pressure comfort value is not within a preset comfort value range, marking out-of-range influencing elements and returning to step 1.2;
if the pressure comfort value is within the preset comfort value range, proceeding to a next step;
1.4) obtaining an elastic structure of material through regression calculation on the basis of the dynamic basic version; and
1.5) obtaining a weight pressure of the clothing and accessories on the clothing and an increased pressure of shrinkage;
if the weight pressure of the clothing and the accessories on the clothing and the increased pressure of shrinkage are not within the preset comfort value range, marking out-of-range influencing elements and returning to step 1.4;
if the weight pressure of the clothing and the accessories on the clothing and the increased pressure of shrinkage are within the preset comfort value range, proceeding to a next step.

2. The method of claim 1, wherein the step 2 comprises:
2.1) obtaining an outline of the main structure of the clothing;
2.2) converting the outline into design plans; and
2.3) marking the processing elements on the design plans, wherein the processing elements comprise overlapping areas, stitches and curved cut edges.

3. The method of claim 2, wherein in the step 2.1, the outline of the main structure of the clothing comprises plane outline design drawings of front, left, right and back of the main structure of the clothing.

4. The method of claim 3, wherein in the step 2.2, the plane outline design drawings are converted into design plans through dots and lines.

5. A method for manufacturing clothing, comprising:
obtaining sketches through the method of simulating clothing comfort of claim 1; and
manufacturing clothing according to the sketches.

6. A method for manufacturing clothing, comprising:
obtaining sketches through the method of simulating clothing comfort of claim 2; and
manufacturing clothing according to the sketches.

7. A method for manufacturing clothing, comprising:
obtaining sketches through the method of simulating clothing comfort of claim 3; and
manufacturing clothing according to the sketches.

8. A method for manufacturing clothing, comprising:
obtaining sketches through the method of simulating clothing comfort of claim 4; and
manufacturing clothing according to the sketches.

9. A system for simulating clothing comfort, comprising:
a module M1 for building a main structure of clothing;
a module M2 for performing a clothing entity design on the main structure of clothing and mark processing elements on sketches;
a module M3 for outputting the sketches;
wherein the module M1 comprises:
a sub-module M1.1 for establishing a dynamic basic version in combination with a size data set and a baseline architect; wherein a basic version that is most similar to a design target is selected as the baseline architect, and the dynamic basic version is dynamically constructed according to the baseline architect and the size data set;
a sub-module M1.2 for obtaining a rigid support structure and an initial style support structure through regression calculation on the basis of the dynamic basic version; wherein the rigid support structure is a support structure of the dynamic basic version that supports a contact surface of the the human body and the dynamic basic version;
a sub-module M1.3 for obtaining a pressure comfort value of the contact surface according to total area and weight of a fabric, tension and a distribution of the contact surface, and an overall force and force decomposition that are determined by the rigid support structure and the initial style support structure;
wherein if the pressure comfort value is not within a preset comfort value range, out-of-range influencing elements are marked, and the sub-module M1.2 is triggered;
if the pressure comfort value is within the preset comfort value range, a sub-module M1.4 is triggered;
the module M1 further comprises:
a sub-module M1.4 for obtaining an elastic structure of material through regression calculation on the basis of the dynamic basic version; and
a sub-module M1.5 for obtaining a weight pressure of the clothing and accessories on the clothing and an increased pressure of shrinkage;
if the weight pressure of the clothing and the accessories on the clothing and the increased pressure of shrinkage are not within the preset comfort value range, out-of-range influencing elements are marked, the sub-module M1.4 is triggered; and
if the weight pressure of the clothing and the accessories on the clothing and the increased pressure of shrinkage are within the preset comfort value range, the module M2 is triggered.

10. The system of claim 9, wherein the module M2 comprises:
a sub-module M2.1 for obtaining an outline of the main structure of the clothing;
a sub-module M2.2 for converting the outline into the design plans; and
a sub-module M2.3 for marking the processing elements on the design plans;
wherein in the sub-module M2.1, the outline of the main structure of the clothing comprises plane outline design drawings of front, left, right and back of the main structure of the clothing;
in the sub-module M2.2, the plane outline design drawings are converted into design plans through dots and lines; and
in the sub-module M2.3, the processing elements comprise: overlapping areas, stitches and curved cut edges.

11. A non-transitory computer-readable storage medium having thereon stored a computer program, wherein the computer program, when executed by a computer, causes the computer to perform the method of claim 1.

12. A non-transitory computer-readable storage medium having thereon stored a computer program, wherein the computer program, when executed by a computer, causes the computer to perform the method of claim 2.

13. A non-transitory computer-readable storage medium having thereon stored a computer program, wherein the computer program, when executed by a computer, causes the computer to perform the method of claim 3.

14. A non-transitory computer-readable storage medium having thereon stored a computer program, wherein the computer program, when executed by a computer, causes the computer to perform the method of claim 4.
